(19) United States
(12) Patent Application Publication
(10) Pub. No.: US 2015/0156999 A1
(43) Pub. Date: Jun. 11, 2015

(54) FLEXIBLE GUIDE APPARATUS AND SYSTEM FOR FISHING LINE

(71) Applicants: Doug Roberts, Dutch John, UT (US); Brian Westover, Pleasant Grove, UT (US)

(72) Inventors: Doug Roberts, Dutch John, UT (US); Brian Westover, Pleasant Grove, UT (US)

(21) Appl. No.: 14/490,371

(22) Filed: Sep. 18, 2014

Related U.S. Application Data
(60) Provisional application No. 61/879,489, filed on Sep. 18, 2013.

(51) Int. Cl. A01K 87/04; A01K 87/00

(52) U.S. Cl. CPC A01K 87/04; A01K 87/00

(57) ABSTRACT

The disclosure extends to fishing devices and implements, and more particularly, but not necessarily entirely, to a flexible guide apparatus and system for fishing line for use with a fishing pole or rod.

### CROSS-REFERENCE TO RELATED APPLICATIONS

This application claims the benefit of U.S. Provisional Application No. 61/879,489, filed Sep. 18, 2013, which is hereby incorporated by reference herein in its entirety, including but not limited to those portions that specifically appear hereinafter, the incorporation by reference being made with the following exception: In the event that any portion of the above-referenced application is inconsistent with this application, this application supercedes said above-referenced application.

### STATEMENT REGARDING FEDERALLY SPONSORED RESEARCH OR DEVELOPMENT

Not applicable.

### BACKGROUND

The disclosure generally relates to fishing devices and implements, and more particularly, but not necessarily entirely, to a flexible guide apparatus and system for fishing line for use with a fishing pole or rod.

Fishing is an activity and sport that can be performed in various climates and in various locations, such as oceans, lakes, ponds, rivers and streams. Fishing may be for commercial, recreational or artisanal (survival) purposes. In any case, fishing may be performed using a variety of techniques and a variety of equipment or tackle.

In recreational fishing, there is great variety in the types of fish that are sought after or targeted and the types of equipment or tackle used to catch those different types of fish. A common form of recreational fishing is done with a rod, reel, line, hooks and any one of a wide range of baits. Other devices may also be used to affect or complement the presentation of the bait to the targeted fish. Some examples of such equipment, sometimes referred to as terminal tackle, include weights, floats, and swivels. Lures may also be used in place of bait. Some hobbyists make handmade tackle themselves, including plastic lures and artificial flies.

In recent years, fly fishing and other types of rod fishing have become increasingly popular as a recreational or sporting activity. Fly fishing uses an artificial fly to catch fish. In fly fishing, a small substantially weightless hooked lure that resembles a fly or other bug is cast into the water. Normally, the lure is attached to a monofilament “leader” that is virtually transparent in the water. The leader is attached to a line, which is usually opaque. For most species of fish, the fly fisherman uses either a surface-type fly or one that swims underwater. The fly is cast using a fly rod, reel and specialized weighted line. Casting in fly fishing may be considered an art form because an angler is casting a nearly weightless fly or lure. Casting a fly requires skill and technique.

There are certain problems that an angler faces when fishing in colder months or climates. As an angler casts and reels the line back and forth several times during the colder months the guide for the fishing line ices up constricting or narrowing the opening within the guide for the line to travel through. Icing-up of one or more of the guides or eyelets may occur as the fishing line moves in and out of the water. As the fishing line is reeled or otherwise brought in and retrieved by the angler, there is contact between the wet fishing line and the guides or eyelets. The water on the line will be scraped off onto the guide or eyelet, such that (when fishing in colder temperatures) the opening of the guide or eyelet is constricted or narrowed due to the icing-up. The result is a noticeable disruption in the casting and retrieving of the fishing line, such that the angler must clear the guides in some manner to allow the line to cast and retrieve freely without interference from the ice that has built up in the guide. Depending upon the temperature and the amount of moisture present on the guide of the fishing pole or rod, the number of casts performed may be severely limited by the icing up of the guides on a fishing pole or rod leading to frustration for the angler who has to take time to clear the guide. It is often difficult or time consuming for an angler to clear ice from a rigid guide member because of the rigidity of both the ice and the guide along with cold temperatures.

What is needed are methods and systems that are efficient at either limiting the amount of ice buildup on a guide of a fishing pole or rod or an easy and simple method of clearing the ice buildup on a guide of a fishing pole or rod. As will be seen, the disclosure provides such methods and systems that can limit or clear the ice buildup on a guide of a fishing pole or rod in an effective and elegant manner.

The features and advantages of the disclosure will be set forth in the description that follows and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates an exemplary implementation of a fishing pole or rod utilizing a guide for directing fishing line therethrough made in accordance with the teachings and principles of the disclosure;

FIG. 2 illustrates an exemplary system including a fishing pole or rod, fishing line and guide for directing the fishing line therethrough made in accordance with the teachings and principles of the disclosure;

FIG. 3 illustrates an exemplary system including a fishing pole or rod, fishing line and guide for directing the fishing line therethrough made in accordance with the teachings and principles of the disclosure;

FIG. 4 illustrates an example of ice buildup on a guide of a fishing pole or rod and a method of clearing the ice buildup in accordance with the teachings and principles of the disclosure;

FIG. 5 illustrates an example of a guide having a flexible looped portion forming an opening for fishing line to pass therethrough, and an anchoring portion and a stem portion that reside within a fastener on a fishing pole or rod and made in accordance with the teachings and principles of the disclosure; and

FIG. 6 illustrates an example of a guide having a flexible looped portion forming an opening for fishing line to pass therethrough, an anchoring portion and a stem portion made in accordance with the teachings and principles of the disclosure.

### DETAILED DESCRIPTION

The disclosure extends to fishing devices and implements, and more particularly, but not necessarily entirely, to a flexible guide apparatus and system for fishing line for use with a fishing pole or rod. In the following description of the disclosure, reference is made to the accompanying drawings, which form a part hereof, and in which is shown by way of illustration specific implementations in which the disclosure is may be practiced. It is understood that other implementations may be utilized and structural changes may be made without departing from the scope of the disclosure.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the structural features and methods are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

In describing and claiming the present disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any feature, element, step, or ingredient not specified in the claim.

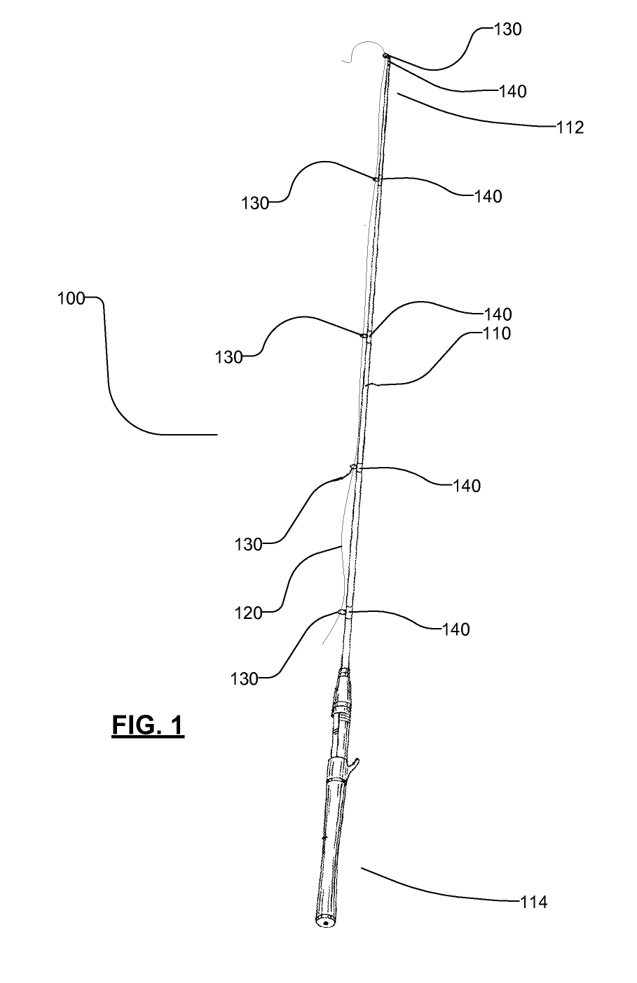

Referring now to FIG. 1, there is illustrated an exemplary system 100 of the disclosure. The system 100 illustrated may comprise a pole or rod 110, such as a fishing pole or rod used in fly fishing or in any other type of fishing, a fishing line 120, a guide 130, which may be one or a plurality of guides 130, for directing the fishing line 120 therethrough, and a wrap or fastener 140 to attach the guide 130 to the pole or rod 110.

The pole or rod 110 may be a long, flexible length of glass fiber composite, carbon fiber composite, or (classically) bamboo, used to catch fish. However, it will be appreciated that the fishing pole or rod may be made from any suitable material known in the art for fishing poles or rods. It will be appreciated that a large variety of fishing poles or rods 110 may be used and employed by the disclosure. Fishing poles or rods vary in flexibility and length. For example, most fishing poles or rods vary between about 24 inches and 20 feet in length. The longer the rod, the greater the mechanical advantage in casting.

Different types of poles or rods 110 may be used, for example, in bait fishing, fly-fishing, ice fishing, surf fishing, and other types of fishing and all such poles and rods are within the scope of the disclosure. For instance, fly-fishing rods are typically long, thin, and flexible to enable casting a lightweight fly. Fly-fishing rods also typically include only a small portion of handle extending below a reel (not shown). In contrast, and by way of further example, surf rods that are used for ocean fishing are much thicker to facilitate casting heavy lures or baits beyond the surf. Surf rods include a long handle to enable two-handed casting. In addition to the extremes of fly-fishing and surf fishing rods, many other rod lengths and thicknesses are employed and all such rods are intended to fall within the scope of the disclosure.

The fishing pole or rod 110 illustrated in FIG. 1 may comprise a rod having a proximal end 112 and a distal end 114, where the proximal end 112 receives a grip and the distal end 114 includes one flexible line guide 130 as disclosed herein for receiving a fishing line 120. In an implementation, the distal end may include more than one or a plurality of flexible line guides 130, while in another implementation there are only flexible line guides 130 used by the pole or rod 110. The fishing line 120 may be monofilament, braided, fluorocarbon, fly line, a line coated with a PVC or other coating, or any other type of fishing line without departing from the spirit or scope of the disclosure.

Many fishing poles or rods, such as pole 110 in FIG. 1, gradually taper from the butt or proximal end 114 to the tip or distal end 112. The pole or rod may be tight in all of its joints (if any), and may include a smooth, progressive taper. Modern design and fabrication techniques, along with advanced materials such as graphite, boron and fiberglass composites as well as stainless steel have allowed fishing pole or rod manufacturers to tailor the shape and action of fishing poles or rods for greater casting distance, accuracy, and fish-fighting qualities.

Generally, there are three major material types used in manufacturing fishing poles or rods, which include graphite, fiberglass, and bamboo rods, but all material types used for manufacturing a fishing pole or rod are intended to fall within the disclosure. It will be appreciated that bamboo poles or rods may be the heaviest of the three major material types, but bamboo poles or rods are still used because of the tactical feel to a user. Fiberglass poles or rods may be considered the heaviest of the new poles or rods that are chemically made materials and tend to be most popular among new and young fisherman because of their strength and durability. The most popular fishing pole or rod material tends to be graphite because of its light weight characteristics and its ability to allow for better and more accurate casting.

Many fishing poles or rods retain cork as a common material for grips. Cork is light, durable, keeps warm and tends to transmit rod vibrations better than synthetic materials, although EVA foam and other materials are also used. Reel seats are often of graphite-reinforced plastic, aluminum, or wood. Traditionally, guides have been available in steel and titanium with a wide variety of high-tech metal alloy inserts replacing the agate inserts used in earlier fishing poles and rods.

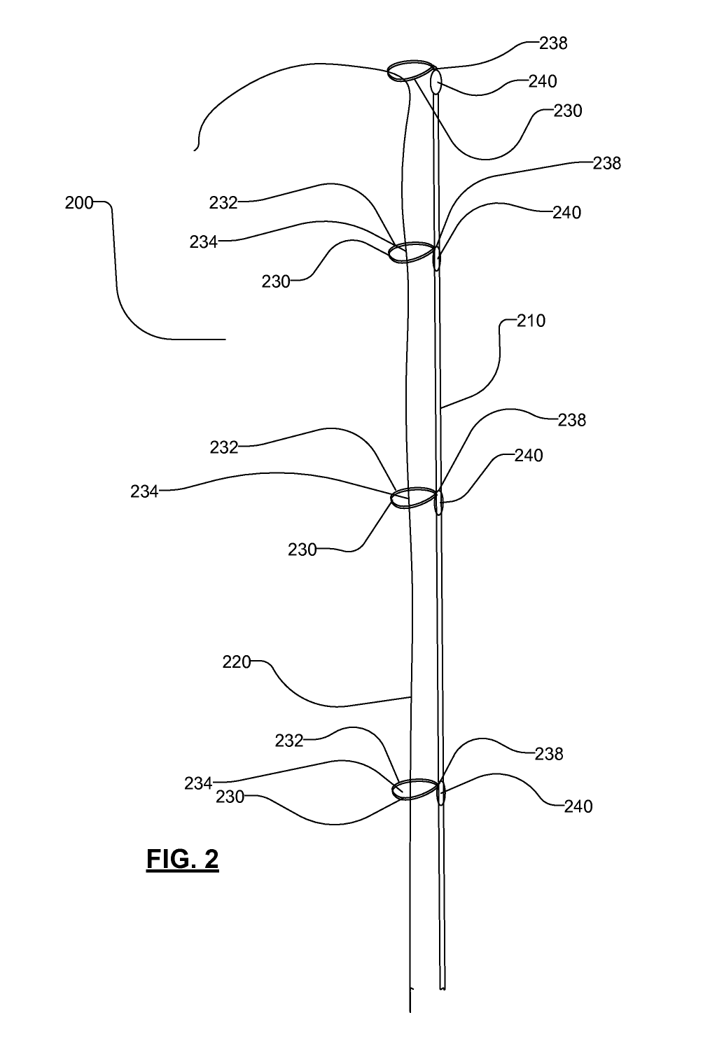

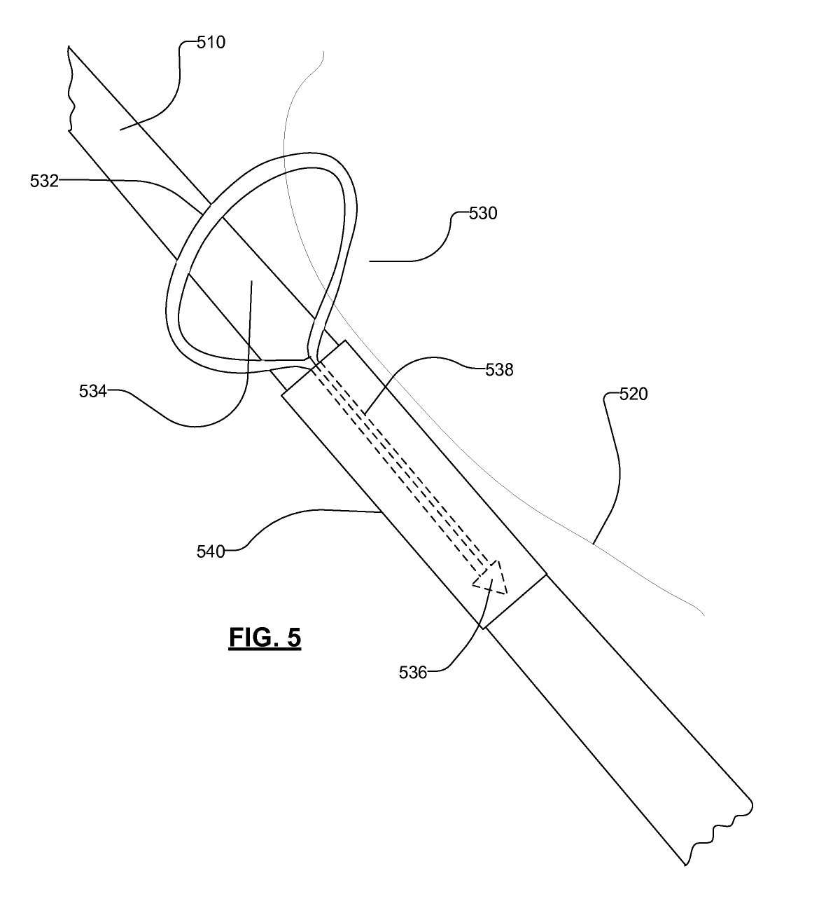

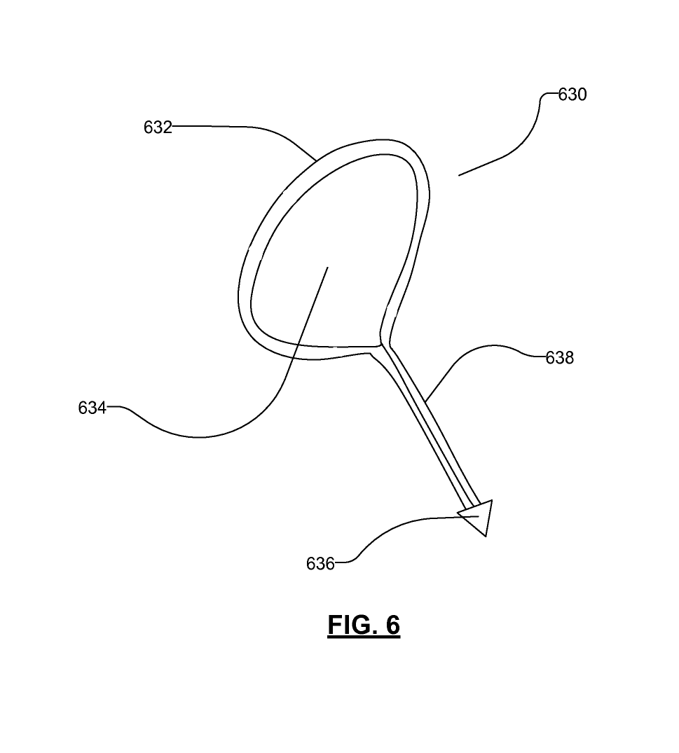

Referring now to FIGS. 2-6, it will be appreciated that as used in the specification like reference numerals refer to like features or elements throughout the specification. For example, the guide 130 is similar to guide 230, 330, etc. and includes the same features and elements, unless otherwise noted. Referring now to FIG. 2, the guide 230 for receiving and guiding the fishing line 220 illustrated therein may comprise a flexible looped portion 232 forming an opening 234 for fishing line 220 to pass there through, an anchoring portion 236 (illustrated best in FIGS. 5 and 6), and a stem portion 238 mechanically connecting the looped portion 232 and the anchoring portion 236. The looped portion 232 and the stem portion 238 may be made from a single filament such that the stem portion 238 may be formed by opposing portions of the single filament that may be brought together for a predetermined length. The anchoring portion 236 may be wider than the stem portion 238 and disposed on the stem portion 238 so as to attach to both of the opposing portions of the single filament. In one implementation, the anchoring portion 236 may be a barb or a plurality of barbs. It will be appreciated that the guide 230 for receiving and guiding the fishing line 220 may be made from a UV resistant material, such as a fluorocarbon polymer material, which tends to be more abrasion resistant than monofilament, or a monofilament material, or another polymeric material, or another filament that is flexible and comprises the properties disclosed herein.

It will be appreciated that in an implementation, the looped portion 232 and the stem portion 238 may be formed from a homogeneous material in a molded process such that the looped portion 232, stem portion 238, and anchor portion 236 form a unitary structure.

In an implementation, the anchor portion 236 may be formed from the same material as the stem portion 238. In an implementation, the anchor portion 236 may be formed from a different material than the stem portion 238. In an implementation, the anchor portion 236 may comprise a metallic material to anchor and secure the guide 230 to the rod or pole 210 via the wrap 240.

It will be appreciated that, in an implementation, the opposing portions of the single filament that are used to form the stem portion 238 may be parallel to one another. In an implementation, the opposing portions of the single filament that are used to form the stem portion 238 may not be parallel to one another. In an implementation, the opposing portions forming the stem portion 238 may be different lengths.

In an implementation, the anchor portion 236 may connect the opposing portions of the single filament together.

In an implementation, a cross-section of the filament may be asymmetrical. In an implementation, a cross-section of the filament may be symmetrical.

In an implementation, the looped portion 232 may be substantially circular. In an implementation, the looped portion 232 may be oval or otherwise a non-circular shape. The looped portion 232 may comprise a V-shaped portion within the looped portion 232.

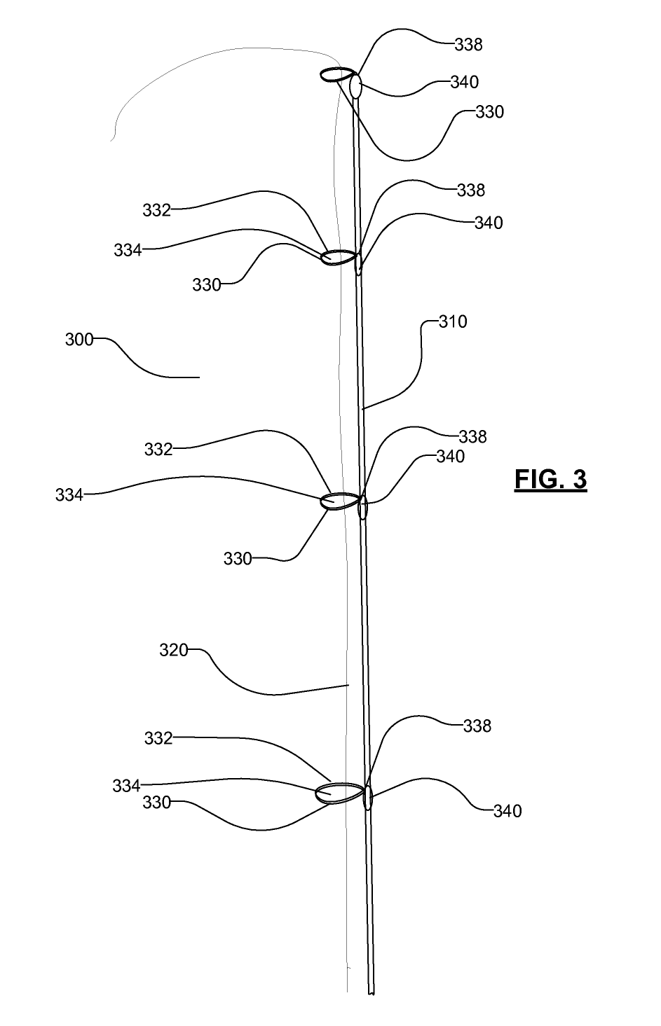

Referring now to FIG. 3, it will be appreciated that a device used for fishing may comprise a pole or rod 310 and a plurality of guides 330 for fishing line 320 disposed along the pole or rod portion 310. In an implementation, at least one of the plurality of guides 330 may comprise a flexible looped portion 332 forming an opening 334 for fishing line 320 to pass therethrough and a stem portion 338 that may be mechanically connected to the looped portion 332 and an anchoring portion 336. In an implementation, the looped portion 332 and the stem portion 338 may be made from a single filament, such that the stem portion 338 may be formed by opposing portions of the single filament that are brought together for a predetermined length. In an implementation, the opposing portions of the single filament that are brought together to form the stem portion 338 may be parallel to each other, whereas in other implementations parallel opposing portions are not required.

Continuing to refer to FIG. 3, in an implementation, the plurality of guides may each comprise loops that vary in size corresponding to the distance from the tip of the pole or rod, where the smallest loops may be part of a guide that is located at the tip of the pole or rod.

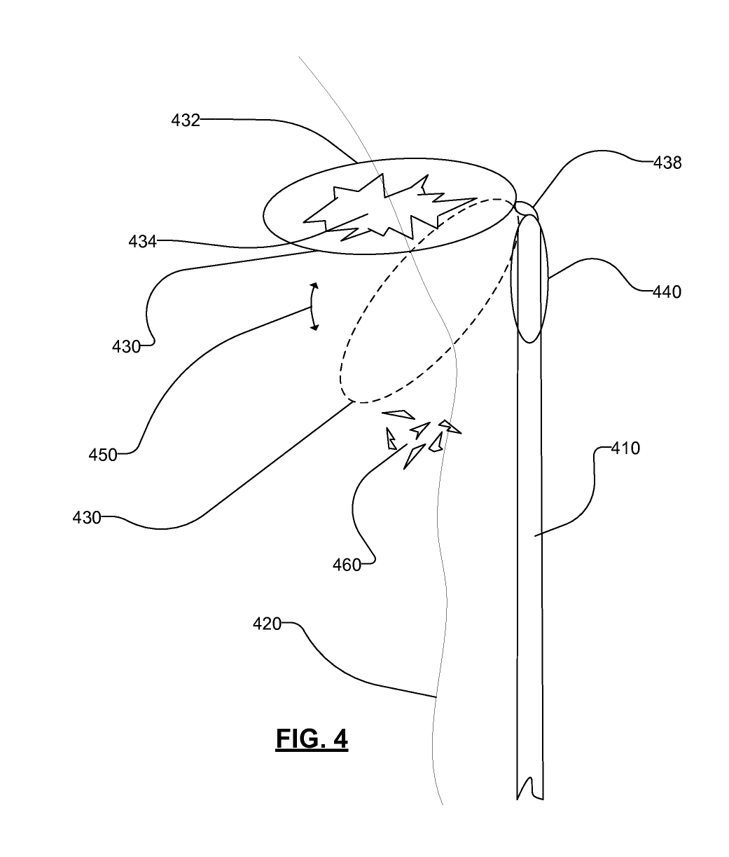

Referring now to FIG. 4, there is illustrated a flexible guide 430 having ice buildup formed around the circumference of the opening 434, thereby substantially blocking the fishing line 420 from moving freely within the opening 434. In an implementation, the flexible guide 430 may be biased, moved or otherwise flexed in the direction of arrow 450. The flexible guide is illustrated as being in its biased, moved or otherwise flexed position as illustrated by the dashed lines in FIG. 4. Because ice is rigid, when the bias is released from the flexible guide 430, the flexible guide 430 will move or return back to its original unbiased position thereby causing the ice buildup to break apart or flake off of the flexible guide 430 as illustrated by the individual shards of ice 460 falling from the guide 430.

Referring now to FIGS. 5-6, in an implementation, the anchoring portion 536 and 636 may be wider than the stem portion 538 and 638 and may be disposed on the stem portion 538 and 638 so as to attach to both of the opposing portions of the single filament. In an implementation, the guide 530 and 630 may be attached to the pole or rod 510 (not illustrated in FIG. 6) at the stem portion 538 and 638, such that the stem portion 538 and 638 may be oriented substantially parallel to the pole or rod 510 and the looped portion 532 and 632 protrudes from the pole or rod 510.

It will be appreciated that in an implementation, the looped portion 632 and the stem portion 638 may be formed from a homogeneous material in a molded process such that the looped portion 632, stem portion 638, and anchor portion 636 form a unitary structure. Additionally, cross-sections of the various components may vary in order to control durability and flexibility by adjusting the relative amounts of material that make up each portion.

In an implementation, a first guide of the plurality of guides is disposed at a tip of the pole or rod and comprises the flexible looped portion. It will be appreciated that in an implementation, the other guides of the plurality of guides may be rigid. Alternatively, it will be appreciated that in an implementation, the other guides of the plurality of guides may be flexible.

In an implementation, the guide may be attached or secured to the pole or rod with thread and epoxy.

In an implementation, a guide for fishing line may comprise a flexible looped portion forming an opening for fishing line to pass therethrough, an anchoring portion, and a stem portion that may be mechanically connected to the looped portion and the anchoring portion. In an implementation, the anchoring portion may be wider than the stem portion and may be disposed on the stem portion.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

In the foregoing description, various features of the disclosure are grouped together in a single implementation for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed implementation. Thus, the following claims are hereby incorporated into this Detailed Description by this reference, with each claim standing on its own as a separate implementation of the disclosure.

What is claimed is:

1. A guide for fishing line comprising:
a flexible looped portion forming an opening for fishing line to pass therethrough;
a stem portion that protrudes from the flexible looped portion;
wherein the looped portion and the stem portion are made from a unitary flexible material;
wherein the stem portion is configured to be attached to a fishing rod.

2. The guide of claim 1, wherein the guide is made of a fluorocarbon polymer.

3. The guide of claim 1, wherein the looped portion and the stem portion are formed from a homogeneous molded material.

4. The guide of claim 1, wherein the stem portion protrudes out from the looped portion to form a foot for attaching to a fishing rod.

5. The guide of claim 1, wherein the loop portion has a varied cross section throughout the length of the loop.

6. The guide of claim 1, wherein the stem portion comprises a metallic material.

7. The guide of claim 1, further comprising an anchor portion.

8. The guide of claim 7, wherein an area of a cross-section of the anchor portion is greater than an area of a cross-section of the stem portion.

9. The guide of claim 1, wherein the looped portion is substantially circular.

10. The guide of claim 1, further comprising a V-shaped portion within the looped portion.

11. A device used for fishing comprising:
a fishing rod;
a plurality of guides for fishing line disposed along the fishing rod wherein at least one of the guides comprises:
a flexible looped portion forming an opening for fishing line to pass there through;
a stem portion that protrudes from the flexible looped portion;
wherein the looped portion and the stem portion are made from a unitary flexible material;
wherein the stem portion is configured to be attached to a fishing rod;
wherein the guide is attached to the fishing rod at the stem portion such that the stem portion is oriented such that the looped portion protrudes from the fishing rod.

12. The fishing device of claim 11, wherein a first guide of the plurality of guides is disposed at the tip of the fishing rod and comprises the flexible looped portion.

13. The fishing device of claim 12, wherein the other guides of the plurality of guides are rigid.

14. The fishing device of claim 11, wherein the plurality of guides comprise loops that vary in size corresponding to the distance from the tip of the fishing rod.

15. The fishing device of claim 11, wherein the guide is attached to the fishing rod with thread and epoxy.

16. The fishing device of claim 11, wherein the guide is made of fluorocarbon polymer.

17. The fishing device of claim 11, wherein the looped portion and the stem portion are formed from a homogeneous material.

18. The fishing device of claim 11, further comprising an anchor portion.

19. The guide of claim 18, wherein an area of a cross-section of the anchor portion is greater than an area of a cross-section of the loop portion.

20. The guide of claim 11, wherein the looped portion is substantially circular.

21. The guide of claim 11, further comprising a V-shaped portion within the looped portion.
